(19) United States
(12) Patent Application Publication
(10) Pub. No.: US 2021/0092964 A1
(43) Pub. Date: Apr. 1, 2021

(54) METHOD FOR MAKING AN ARTISANAL LOOKING PIZZA DOUGH CRUST

(71) Applicant: SOCIETE DES PRODUITS NESTLE S.A., Vevey (CH)

(72) Inventors: Timothy George Prins, Solon, OH (US); Giuseppoe Esposito, Mugnano del Cardinale (IT); Baninder Singh Sroan, Hudson, OH (US); Brunello Bilotti, Atripalda (IT)

(21) Appl. No.: 17/044,695

(22) PCT Filed: Apr. 17, 2019
(86) PCT No.: PCT/EP2019/059906

§ 371 Date: Oct. 1, 2020

(30) Foreign Application Priority Data
Jun. 15, 2018 (EP) 18178070.1

(51) Int. Cl. A21D 13/41; A21C 11/00

(52) U.S. Cl. CPC A21D 13/41; A21D 8/02; A21C 11/006

(57) ABSTRACT

The present invention relates to a method for making an artisanal looking pizza dough crust comprising the step of placing a bread-type dough ball onto a flat surface and pressing said dough ball with a heating plate, wherein the flat surface and the heating plate do not form a cavity or contained area under the press, wherein the flat surface and the heating plate do not have a groove, gutter, indentation or protrusion for forming a rim of the dough upon pressing, and wherein the surface area of the heating plate is smaller than the surface area of the dough after pressing. A further aspect of the invention pertains to the pizza obtained by said method.

The present invention relates to a method for industrially making an artisanal looking pizza dough crust having a rim. A further aspect of the invention pertains to the pizza obtained by said method.

Today's consumers prefer pizza products which are handmade over such pizza products which are mechanically and industrially made by machines. Such products are perceived by consumers as fresher, more traditional, more premium quality, pizzeria made quality, and are therefore preferred. One of the critical elements consumers focus when judging about such premium quality pizza products is the pizza dough crust, especially the outer crust.

The artisanal way of making such traditional pizza dough crusts typically involves first keeping a raw pizza dough in the form of a ball or loaf, and preferably to let it rest for a certain period of time at room or some elevated temperature in order to let it proof, and then to form or shape the dough ball into a more or less round, thin and flattened dough disk by hand using the fingers and/or other kitchen aid instruments. Thereafter, typically an elevated rim is formed at the edge of the dough disk by hand in order to prevent toppings like e.g. tomato sauce from flowing off the dough crust before or during the baking of the finally topped pizza product. The rim, i.e. outer crust, is made elevated also to allow pick up of the pizza slice by hand and provide the experience of the superior crust flavour and texture without the tomato sauce.

Industrial ways of making and forming pizza doughs typically make use of specifically designed pizza pressing machines that use pressing dies with moulded shapes to form/press raw pizza dough into a flat disk having an elevated rim at the edge. For example U.S. Pat. No. 5,074,778 describes such a typical dough forming press. Disadvantages of such industrial pizza dough presses are that they typically leave very clear and uniform marks originating from the moulds or dies used in the process at the bottom, edges and/or rims of such fabricated dough crusts. The resulting edge marks, rim effects and/or uniformity of the dough crusts immediately drive the consumer to understand and realize, that the pizza they are eating is industrially made with machinery. This dramatically lessens the consumer's pizza eating experience, whereas the trend today is to exemplify the hand-made pizzeria eating experience.

Alternative industrial pizza dough presses also exist where the raw pizza dough is pressed between two large flat press plates to result in a flat, more or less round dough disk, but having no elevated rim at the edge of the dough. Such dough presses are commercialized for individual and industrial use e.g. in the USA. The disadvantage of those presses are that the flattened dough disks are left with no elevated rims at the edge.

The desire of consumers for artisanal looking and tasting pizza doughs is strong. Industrially pressing a raw yeast proofed pizza dough with or into a volume-contained mould or die further results in much stress on the rheology of the dough, resulting in a loss of air inclusions. A consequence thereof is that the pizza crust is much more compact, homogenous and hard after baking in comparison to a real handmade artisanal pizza crust, which has larger air cell structures. Furthermore, in most cases clear ‘machined’ edge and rim marks are visible on the pizza crust, even after baking, which originate from the mould or die in the pressing process of the dough.

Hence, there is still a clear and persisting need in the industry to find alternatives and/or better solutions for industrially making an artisanal looking pizza dough crust.

The object of the present invention is to improve the state of the art and to provide a solution to overcome at least some of the inconveniences of the present technologies described above.

The object of the present invention is to provide a method for industrially making an artisanal looking and tasting pizza dough crust. Particularly, the object of the present invention is to provide a method for industrially making an artisanal looking pizza dough crust having an artisanal looking elevated rim.

The object of the present invention is achieved by the subject matter of the independent claims. The dependent claims further develop the idea of the present invention.

Accordingly, the present invention provides in a first aspect a method for making an artisanal looking pizza dough crust comprising the step of placing a bread-type dough ball onto a flat surface and pressing said dough ball with a heating plate, wherein the flat surface and the heating plate do not form a cavity or contained area under the press, wherein the flat surface and the heating plate do not have a groove, gutter, indentation or protrusion for forming a rim of the dough upon pressing, and wherein the surface area of the heating plate is smaller than the surface area of the dough after pressing.

In a second aspect, the invention relates to a pizza dough crust obtainable by the method of the present invention.

A third as aspect of the invention is a pizza product comprising the pizza dough crust of the present invention.

The inventors surprisingly found that when pressing pizza dough billets or dough balls with an industrial press, where the center press plate has an area surface which is smaller than the resulting surface area of the dough after pressing, pizza dough disks are formed which have a naturally formed and looking rim at the edge, resulting from the excess dough material which is pushed out of the press underneath the center press plate. As there are no borders, molds or grooves to form the rim at the edge of the dough disk, there are also no edge marks, equipment indents, rim marks, no marks from die cuts or other traces which would result from the press machinery left on the dough or rim surface. Upon baking of such a pressed dough disk an extremely artisan looking style crust is obtained with no industrial or processing appearance to it. Furthermore, the dough was not pressed in a contained form, but left with enough room for excess dough to escape under the center press plate, and hence to form the rim. There was much less stress on the rheology of the dough for it was not under a contained pressure. Hence, the dough was not compacted, and only minimal air was pressed out of the proofed dough. Also this resulted in a much more natural artisanal aspect, look and taste, of the pizza dough crust after baking, as the crust is less compact, more aerated and has a hand-made like appearance. Less stress on the dough provided the resulting crust with a superior rim and crust volume after baking, and with a lighter texture to the bite.

Further advantages of the present invention observed by the inventors was that there was less sticking of the dough to the center press plate surface. This was probably because the dough was no longer pressurized, squeezed or trapped in a closed and contained area under the press. Heat is normally applied to the center press plate to further reduce the sticking of dough to the press surface. Less heating is necessary for the press of the present invention, and hence also favorably the amount of energy used to heating the press plates can be reduced.

### BRIEF DESCRIPTION OF THE FIGURES

FIG. 1: Artisanal looking pizza dough crust made according to the present invention with a dough ball of Formula A. A) and B) show the dough crust after pressing and before baking; C) shows the dough crust after application of tomato sauce as topping and after baking.

FIG. 2: Artisanal looking pizza dough crust made according to the present invention with a dough ball of Formula B. A) and B) show the dough crust after pressing and before baking; C) shows the dough crust after application of tomato sauce as topping and after baking.

FIG. 3: Artisanal looking pizza dough crust made according to the present invention with a dough ball of Formula B under industrial conditions. A) shows the dough crust after application of tomato sauce as topping and after baking.

### DETAILED DESCRIPTION OF THE INVENTION

The present invention provides in a first aspect a method for making an artisanal looking pizza dough crust comprising the step of placing a bread-type dough ball onto a flat surface and pressing said dough ball with a heating plate, wherein the flat surface and the heating plate do not form a cavity or contained area under the press, wherein the flat surface and the heating plate do not have a groove, gutter, indentation or protrusion for forming a rim of the dough upon pressing, and wherein the surface area of the heating plate is smaller than the surface area of the dough after pressing.

The method of the present invention pertains to press forming the bread-type dough ball with a heating plate into a flat dough disk, wherein the surface area of the dough disk is larger than the surface area of the heating plate after the pressing step, and wherein thereby an elevated rim is formed at the edge of the dough disk. Consequently, after the pressing, the surface area of the heating plate is smaller than the surface area of the dough, respectively the dough disk.

Furthermore, the method of the present invention pertains to press forming the bread-type dough ball with a heating plate into a flat dough disk, wherein the dough texture, the dough rheology, the gas cell structure of the dough and/or the dough matrix is not or only minimally compromised, destroyed and/or reduced.

The advantage of the method of the present invention is that a pizza dough disk can industrially be produced which has the aspect of a hand-made artisanal looking pizza crust after baking. There are no edge marks, equipment indents, rim marks or other traces from press machinery left on the pizza dough or rim crust, which would evoke the impression of an industrially machine made pizza dough crust with the consumer.

Furthermore, the pizza crust and rim is less compact and more aerated, what a consumer would expect from an artisanal hand-made pizza crust and not from an industrially produced pizza crust. The less stress on the dough during the manufacturing process provided the resulting crust with a superior rim and crust volume after baking, and with a lighter texture to the bite. It has a hand-made like aspect, pertaining to the visual appearance as well as to the taste.

Typically the “bread-type dough” used in the method for making an artisanal looking pizza dough crust of the present invention is raw pizza dough. Preferably, the dough is proofed dough which has been prepared fresh and/or which was kept refrigerated before use in the method of the present invention.

A “dough ball” of the present invention is a portioned part of the bread-type dough. It is a block, lump or chunk of the bread-type dough. Preferably it is in a cube-like or a rounded ball or flattened ball-like form, as for example typically formed by hand as a handful of dough.

Preferably, the bread-type dough ball used in the method of the present invention is portioned for a regular size or family size pizza product. Preferably, the dough ball is portioned to a wet-weight before use from 100 g to about 600 g, preferably from 150 g to 450 g, more preferably from 200 g to 300 g, per dough ball.

In a preferred embodiment, the heating plate of the present invention is either flat or convex. This form of the heating plate has the advantage that it first flattens the dough ball sufficiently into a flat dough disk for most of the dough surface after the pressing step. The flat or convex form of the heating plate also makes sure that there is no formation of a contained or closed space under the press giving rise to a compression of the dough under the pressure. Furthermore, a convex or slightly convex form of the heating plate facilitates an equal distribution of the dough under the heating plate when pressed and thereby facilitates a regular evacuation of the excess dough mass from under the press and allows it to form an elevated rim naturally around the edge of the dough disk.

Preferably, in the method of the present invention, the surface area of the heating plate is 95% or less of the surface area of the dough after pressing, i.e. of the surface area of the dough disk after the pressing step. Thereby, the surface area of the dough disk after the pressing step is defined as 100%. This method advantageously allows to form a natural elevated rim of about 5% or more of the surface area of the dough disk around the edge of that dough disk. In a more preferred embodiment, the surface area of the heating plate is 90% or less of the surface area of the dough after pressing. This method would allow to form a natural elevated rim at the edge of the dough disk of about 10% or more of the surface area of the dough after being pressed.

Preferably, in the method of the present invention, the surface area of the heating plate is at least 70%, more preferably at least 75%, even more preferably at least 80%, or more of the surface area of the dough after pressing. This assures that there is still a sufficient large surface space on the pizza crust for applying toppings and/or decorations.

The surface area of the heating plate of the present invention can have any form. It can be round, oval, rectangular, square, rectangular or square with rounded edges, triangular or any other irregular form. In a preferred embodiment, however, the surface area of the heating plate of the present invention is round or oval. This allows the preparation of a typical handmade artisanal type pizza product.

Preferably, the method of the present invention processes a bread-type dough ball which comprises about 55-70 wt % flour, water and salt. Preferably, the dough used in the present method comprises about 60-65 wt % flour. Preferably, the salt content of the dough used in the present invention comprises from about 1 to 3 wt % salt.

In a preferred embodiment of the present invention, the bread-type dough ball comprises an active yeast. Preferably the active yeast is present in the dough from about 0.05 to 0.2 wt % of the total wet-based dough mass. The presence of active yeast facilitates fermenting and proofing of the dough and thereby generates a nice aerated structure of the dough mass, a typical aspect of yeast-rising artisan dough products.

In one embodiment of the present invention, the heating plate is heated. Preferably, the heating place is heated to a temperature from 60° C. to 125° C., preferably from 80° C. to 120° C., more preferably from 90° C. to 115° C. Active heating of the heating plate for the present method allows to accelerate the industrial process of manufacturing pizza dough crusts. The process can be run much faster and the dough disks readily detach much better from the heating plate without sticking to that plate, than when the heating plate is not actively heated.

In another embodiment of the present invention, the flat surface, onto which the bread-like dough ball is placed in the method of the present invention, is heated. This advantageously allows to already start to pre-bake the dough crust during its processing and thereafter also to better detach it again from the flat surface after the pressing process is terminated. Preferably, the flat surface is heated to a temperature of at least 120° C., preferably of at least 160° C., more preferably at least 180° C.

A further aspect of the present invention is a pizza dough crust obtainable by the present method.

A still further aspect of the present invention is a pizza product comprising the pizza dough crust of the present invention. The pizza product may further comprise toppings such as tomato sauce and/or mozzarella cheese. In a preferred embodiment, the pizza product of the present invention is a frozen prepared pizza product.

Those skilled in the art will understand that they can freely combine all features of the present invention disclosed herein. In particular, features described for the method of the present invention may be combined with the product of the present invention and vice versa. Further, features described for different embodiments of the present invention may be combined.

Further advantages and features of the present invention are apparent from the figures and examples.

### EXAMPLES

Control and understanding of the pressing process and use of the equipment for pressing of the dough balls for Pizzas is critical. How and with what kind of equipment the dough is pressed and formed in the shape of the pizza before topping and baking is directly related to how the final pizza, especially the crust appears after baking in shape, height, diameter, texture, and even colour to the consumer. In addition, the pressed dough has an important impact on how evenly the tomato sauce can be applied or spread on the pizza. Last but not least, the pressed dough has an effect on how the final pizza yields through loss topping and packaging.

The main experimental equipment used to pizza dough press testing according to the present invention was a pilot plant pizza press testing machine. The test machine was able to press dough between a heated top press moving downward and a stationary heated bottom surface. The machine allowed for the testing of top press heads of various diameter, shape, and surface treatment. The machine allowed for adjustment in press head temperature. The machine could be adjusted for the amount of force to the dough. The machine could be adjusted for the final distance from the flat surface the dough is placed on to the heating plate to determine the resulting dough thickness during the pressing process. The machine could be adjusted for the time that the press head is held at its lowest position. The machine could be adjusted for the speed and acceleration/deceleration in the downward and upward motion of the press head. The machine had an air pressure release that could be applied during the release action after the pressing step. The machine, tests and process were scalable to test on industrial equipment and to apply to industrial production.

The two following dough compositions were tested as formula A and formula B.

Formula A:

61 kg Flour Wheat Soft

1.2 kg Salt (NaCl)

1.2 kg sunflower oil

0.15 kg active baker's yeast crumble

Water added to 100 kg final dough mass

Formula B:

65 kg Flour Wheat Soft

1.4 kg Salt (NaCl)

1.9 kg sunflower oil
0.15 kg active baker's yeast crumble
Water added to 100 kg final dough mass

### Example 1

Raw dough balls made with Formula A were tested on the experimental pilot plant pizza press as outlined above.

Settings with formula A. Flat press head used having no grooves,
indentions or protrusions capable of forming a rim.

| | |
|---|---|
| Head Pressing Duration (Sec) | 6.0 |
| Poppet (ds.) | 70 to 80 |
| Total Down (mm) | 92.0 |
| Go down fast to (mm) | 92 |
| Motor torque limit (Nm) | 40 |
| Temperture Head (° C.) | 60 |
| Temperature Convey Flat Surface Base (° C.) | 170 |
| Brushless Settings -Offset quota (mm) | 10 |
| Head Speed (mm/sec) | 120 |

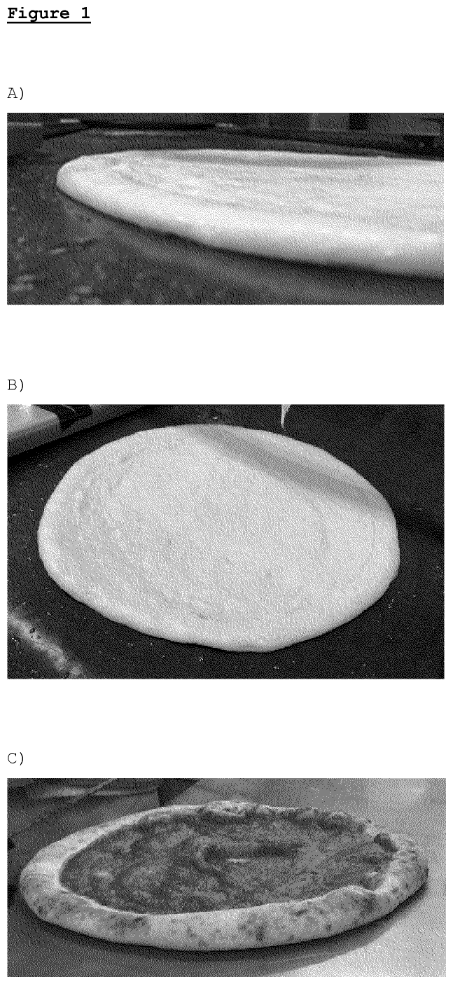

Result is shown in FIG. 1

As can be seen in FIG. 1, the pressed dough disk extended outside of the surface area which was directly pressed by the heating plate of the pizza press, and formed there a slightly elevated rim. Upon baking (see FIG. 1C), formation of this rim became clearer and has a complete natural appearance only known from artisanal handmade pizza crusts.

### Example 2

Raw dough balls made with Formula B were tested on the same experimental pilot plant pizza press as outlined above.

Settings with formula B. Flat press head used having no grooves,
indentions or protrusions capable of forming a rim.

| | |
|---|---|
| Head Pressing Duration (Sec) | 6.0 |
| Poppet (ds.) | 65 to 80 |
| Total Down (mm) | 92.0 |
| Go down fast to (mm) | 92 |
| Motor torque limit (Nm) | 40 |
| Temperture Head (° C.) | 70 |
| Temperature Convey Flat Surface Base (° C.) | 180 |
| Brushless Settings -Offset quota (mm) | 10 |
| Head Speed (mm/sec) | 120 |

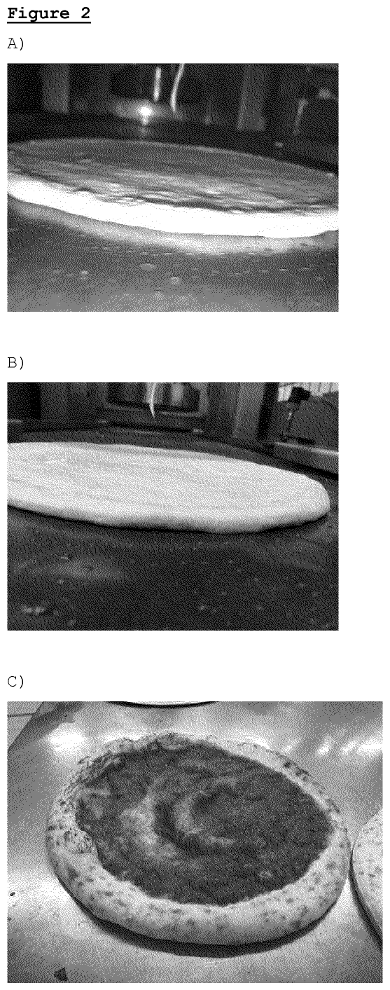

Result is shown in FIG. 2

As can be seen in FIG. 2, the pressed dough disk extended outside of the surface area which was directly pressed by the heating plate of the pizza press, and formed there a slightly elevated rim. Upon baking (see FIG. 2C), formation of this rim became clearer and has a complete natural appearance only known from artisanal handmade pizza crusts.

### Example 3

Raw dough balls made with Formula B were tested on an industrial pizza line using a similar press as outlined above.

Settings with formula B. Flat press head used having no grooves,
indentions or protrusions capable of forming a rim.

| | |
|---|---|
| Head Pressing Duration (Sec) | 5.2 |
| Poppet (ds.) | 50 to 60 |
| Total Down (mm) | 92.0 |
| Go down fast to (mm) | 92 |
| Motor torque limit (Nm) | 50 |
| Temperture Head (° C.) | 80 |
| Temperature Convey Flat Surface Base (° C.) | 220 |
| Brushless Settings -Offset quota (mm) | 10 |
| Head Speed (mm/sec) | 120 |

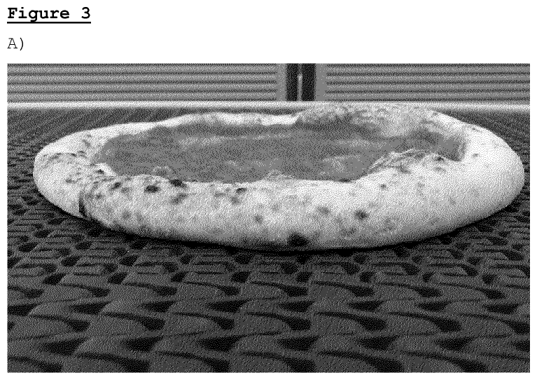

Result is shown in FIG. 3

As can be seen in FIG. 3, the pressed dough disk extended outside of the surface area which was directly pressed by the heating plate of the pizza press, and formed there a slightly elevated rim. Upon baking (see FIG. 3A), formation of this rim became clearer and has a complete natural appearance only known from artisanal handmade pizza crusts.

1. A method for making an artisanal looking pizza dough crust comprising the step of placing a bread-type dough ball onto a flat surface and pressing the dough ball with a heating plate, wherein the flat surface and the heating plate do not form a cavity or contained area under the press, wherein the flat surface and the heating plate does not have a groove, gutter, indentation or protrusion for forming a rim of the dough upon pressing, and wherein the surface area of the heating plate is smaller than the surface area of the dough after pressing.

2. The method according to claim 1, wherein the bread-type dough ball is raw pizza dough.

3. The method according to claim 1, wherein the heating plate is flat or convex.

4. The method according to claim 1, wherein the surface area of the heating plate is 95% or less of the surface area of the dough after pressing.

5. The method according to claim 1, wherein the surface area of the heating plate is 90% or less of the surface area of the dough after pressing.

6. The method according to claim 1, wherein the surface area of the heating plate is at least 70% or more of the surface area of the dough after pressing.

7. The method according to claim 1, wherein the surface area of the heating plate is round or oval.

8. The method according to claim 1, wherein the bread-type dough ball comprises 55-70 wt % flour, water and salt.

9. The method according to claim 1, wherein the bread-type dough ball comprises active yeast.

10. The method according to claim 1, wherein the heating plate is heated to a temperature from 60° C. to 125° C.

11. The method according to claim 1, wherein the flat surface is heated.

12. The method according to claim 11, wherein the flat surface is heated to a temperature of at least 120° C.

13. A pizza dough crust obtainable by the method according to claim 1.

14. A pizza product comprising a pizza dough crust comprising the step of placing a bread-type dough ball onto a flat surface and pressing the dough ball with a heating plate, wherein the flat surface and the heating plate do not form a cavity or contained area under the press, wherein the flat surface and the heating plate does not have a groove, gutter, indentation or protrusion for forming a rim of the dough upon pressing, and wherein the surface area of the heating plate is smaller than the surface area of the dough after pressing.

15. The pizza product according to claim 14, which is a frozen prepared pizza product.
